(19) United States
(12) Patent Application Publication
(10) Pub. No.: US 2008/0307445 A1
(43) Pub. Date: Dec. 11, 2008

(54) METHOD AND APPARATUS FOR PROVIDING A UNIFIED SYSTEM FOR INTERACTION WITH CELLULAR AND INTERNET PROTOCOL DEVICES

(76) Inventor: Sukesh Garg, San Jose, CA (US)

Correspondence Address: THORNE & HALAJIAN;APPLIED TECHNOLOGY CENTER, 111 WEST MAIN STREET, BAY SHORE, NY, 11706, US

(21) Appl. No.: 11/758,467

(22) Filed: Jun. 5, 2007

(51) Int. Cl. G06F 3/00

(52) U.S. Cl. 719/328

(57) ABSTRACT

A method of providing a unified system for interaction with cellular and internet protocol devices. The method includes receiving device position information from an Access Point (AP), receiving a service request for the device from a cellular based service system, and providing information to the device responsive to the service request and the device position information. The method may include evaluating the device position information and translating the device position information to suitable position information based on the service request.

### FIELD OF THE PRESENT SYSTEM

The present system relates to a method and apparatus for providing a unified system for interaction with cellular and internet protocol devices.

### BACKGROUND OF THE PRESENT SYSTEM

A multitude of systems are being developed to enable providing services utilizing a cellular network. However, service developers and providers are hampered by the complexity of the cellular communication network involved in creating and providing the services. To facilitate services development and deployment, an application programming interface (API) called Parlay has been developed that has tools to provide system level function call abilities, without intimate knowledge of the programming structure for the underlying system.

Parlay enables a multitude of different service deployments that are based on a standardized set of tools. One such service involves an invocation of electronic 911 emergency calls (E911). E911 service is used to notify a public safety answering point (e.g., medical, police, fire, etc.) about emergencies such as a critical medical condition or criminal activity. The location information can also be used to provide enhanced local services to the consumer based on a user's location. For example, through use of location information, information on local businesses may be provided to the user. With land lines and mobile phones, the information is provided automatically using a variety of techniques such as a database correlating phone numbers to a given location, Global Positioning System (GPS), Assisted-GPS (AGPS), Advanced Forward Link Trilateration (AFLT), and AGPS together with AFLT.

Currently, there is a huge adoption of Voice over Internet Protocol (VoIP) telephony providing voice services similar to traditional landlines and cellular phones. In addition, phones are getting equipped with VoIP clients to make calls using an 802.11 wireless (WiFi) network. An example is a Skype™ client loaded on a cellular phone. As per government rules and regulations, VoIP services must also provide E911 services. This means that VoIP operators will have to provide location information for VoIP users. To solve this problem, VoIP operators are utilizing a static registration database similar to landline operators, wherein a given Access Point (AP) is associated with a fixed address. This solution does not solve a problem wherein a user is not located adjacent to the AP. In fact, in a typical wireless AP, a user may be located quite a distance from the wireless AP. Further, with cellular phones able to dynamically switch between cellular and WiFi connections, an integrated approach is required that enables communication between existing systems.

It is an object of the present system to overcome disadvantages and/or make improvements in the prior art.

### SUMMARY OF THE PRESENT SYSTEM

The present system includes a system, method and device for providing a unified system for interaction with cellular and internet protocol devices. The method includes receiving device position information from an Access Point (AP), receiving a service request for the device from a cellular based service system, and providing information to the device responsive to the service request and the device position information. The method may include evaluating the device position information and translating the device position information to suitable position information based on the service request.

Receiving the device position information may include receiving updated device position information and updating the information to the device responsive to the updated device position information. Further acts may include evaluating a difference between the updated device position information and the device position information and providing the information to the device responsive to the difference. Evaluating the difference may include evaluating the difference to determine a rate of travel of the device to determine if the device is traveling at a vehicular rate of travel and providing the information to the device including an area around the device based on if the device is traveling at a vehicular rate of travel. Evaluating the device position information may utilize a location database and a location rules manager. A determination may be made if the device switches to a cellular Access Point (AP). If the device switches to the cellular AP, the method may include receiving further device position information from the cellular AP and providing updated information to the device responsive to the service request and the updated device position information.

The device position information may include position information related to an altitude. The method may include evaluating the altitude of the device, converting the altitude to a floor location of the device and providing the information to the device responsive to the altitude of the device. The position information may include coordinate position information that may include a coordinate related to an altitude of the device.

The device may include a WiFi network, an Access Point (AP) within the WiFi network, a service-based server, such as a Parlay server, a location server, a location rules manager and a location database. The location server may evaluate a devices position and respond to the device based on a service request from the service server and based on the devices position. The location server may include a location mapping engine, a location rules engine and a location correlation engine. The location mapping engine may map the device's location based on the device's position received from the AP and based on information from the location database. The location correlation engine may correlate the device's location to suitable service information utilizing the location rules manager and the service request.

### BRIEF DESCRIPTION OF THE DRAWINGS

The invention is explained in further detail, and by way of example, with reference to the accompanying drawings wherein:

FIG. 1 shows a system in accordance with an embodiment of the present system; and

FIG. 2 shows a flow diagram in accordance with an embodiment of the present system.

### DETAILED DESCRIPTION OF THE PRESENT SYSTEM

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, circuits, modeling tools, analysis techniques and methods are omitted so as not to obscure the description of the present system. It should be expressly understood that the drawings are included for illustrative purposes and do not represent the scope of the present system.

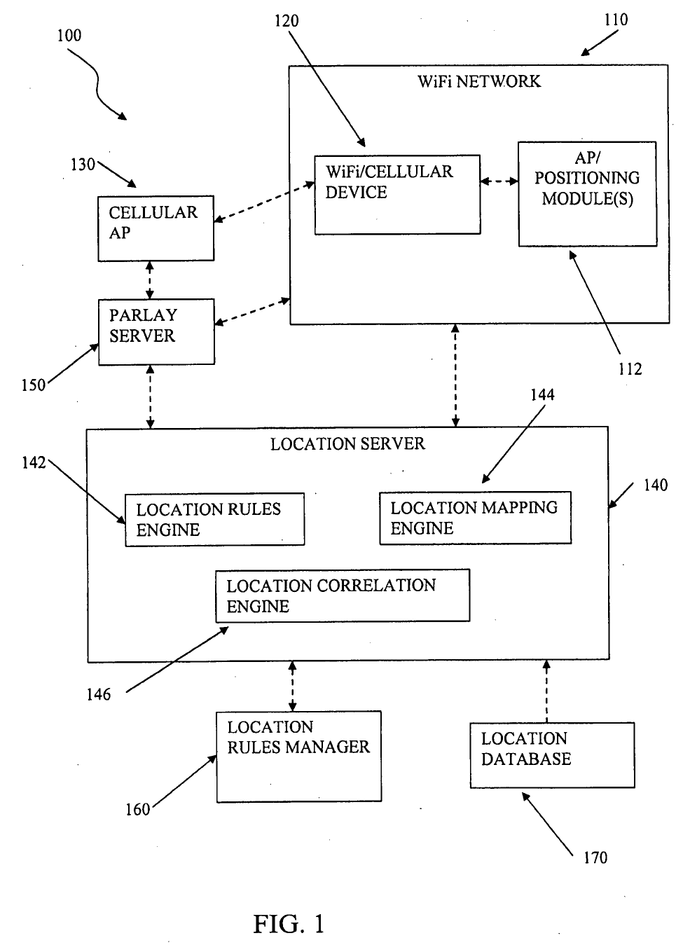

FIG. 1 shows a system 100 in accordance with an embodiment of the present system. The system 100 includes a parlay server 150 that is operably coupled to access point(s) illustratively including AP/positioning module(s) 112, within a WiFi network 110, and cellular AP(s) 130, such as a cellular tower. The WiFi network 110 may be any type of wireless local area network including an area wide network. The parlay server 150 is also operably coupled to a location server 140. For purposes of simplifying a description of the present system, the term operably coupled and formatives thereof as utilized herein refer to an interconnection that enables the related portions to operate in accordance with the present system. An operable coupling may include elements such as a wireless coupling (e.g., a wireless cellular communication coupling, a WiFi coupling), a wired coupling, an optical coupling and other communication couplings including combinations thereof, for example utilizing land-line protocols, network protocols, and combinations thereof.

The location server 140 includes a location rules engine 142, a location mapping engine 144 and a location correlation engine 146. The location rules engine 142, location mapping engine 144 and location correlation engine 146 may include hardware portions, software portions (e.g., programming instructions) and/or combinations thereof. The location mapping engine 144 is arranged to receive device location information, such as coordinate information, AP location information (e.g., from one or more of AP 112, cellular AP 130, etc.), and location database information from a location database 170 (e.g., such as IP location information, cellular tower location information including service area information, etc.). The location mapping engine 144, together with the received information, determines a location of a WiFi/cellular device 120 and provides the device location information to the location rules engine 142. The location rules engine 142 utilizes the device location information together with rules operation instructions from a location rules manager 160 and the location correlation engine 146 to provide services in accordance with service instructions/requests from the parlay server 150.

The services may include services that are filtered based on the devices 120 determined location. For example, a request for business information forwarded by the parlay server 150 may be filtered such that only business information within a given distance from the determined location of the device 120 is provided to the device 120. The given distance may be predetermined (e.g., within a ten block radius, within a 1 mile radius of the device, within a five mile distance, etc.) for example by the user when requesting the service or may be dynamically determined based a rate of travel of the device 120. For example, in one embodiment in accordance with the present system, a determination of location information may be made two or more times within a period of time to identify the rate of travel of the device 120. In a case wherein the rate of travel is indicative of the device 120 traveling at a walking rate (e.g., less than 5 miles per hour), then the given distance may be set at a ten block radius. In a case wherein the rate of travel is indicative of the device 120 traveling at motor vehicle rate (e.g., greater than five miles per hour), then the given distance may be set at a five mile radius. The given distance may also be determined utilizing information regarding congestion information such as provided by the location correlation engine 146 and the location rules engine 142. For example, when the rate of travel is determined to be greater than five miles per hour, the location rules manager 160 may provide operation instructions to set the given distance to five miles unless the location of the device is within a congested area, such as within a city, in which case the given distance is set to one mile. The location correlation engine 146 together with the operating instructions from the location rules manager 160 and the devices location information from the location mapping engine 144 may determine the given distance and provide the given distance to the location rules engine 142. The congestion information may be actual based on actual congestion data in an area around the device 120 or may be expected congestion, such as based on the device 120 location (e.g., within a city or rural area).

The services may include an E911 application that acquires the determined location of the device 120 and provides the determined location to an emergency operator. In this embodiment, the location correlation engine 146 may convert the determined device location from a coordinate space (e.g., longitude and latitude) to an address space (e.g., 110 Tenth Avenue, Bronx, N.Y.) to provide the emergency operator with a human readable device location. Numerous other services would readily occur to a person of ordinary skill in the art and are intended to be covered by the present system.

The devices, such as AP 112, device 120, cellular AP 130, Parlay server 150, location server 140, location rules manager 160 and location database 170 may include a processor operationally coupled to a memory, a display, and a user input device. The interconnections between these may be a wired, wireless, optical, and/or other system or combination thereof for transferring data there between.

The one or more memories including the location database 170 may be any type of device for storing programming application data, such as to support a user interface (e.g., GUI), as well as other data, such as Parlay tools, location correlation data, etc. The programming application data and other data are received by the one or more processors for configuring the one or more processors to perform operation acts in accordance with the present system. The operation acts may include controlling a display to display a graphical user interface (GUI) for user interaction with the present system, and configuring the one or more processors. The user input may include a keyboard, mouse, trackball, accelerometer or other device, such as a touch sensitive display, which may be stand alone or be a part of a system, such as part of a personal computer, personal digital assistant, a rendering device (e.g., MP3 player) and/or display device for communicating with the processor 710 via any type of link, such as a wired or wireless link. The user input device is operable for interacting with the processor including interaction within a paradigm of a GUI for interaction with elements of the present system, such as a request for an E911 service. Clearly the one or more processors, memories, displays, and/or user input devices may all or partly be a portion of a computer system or other device.

The methods of the present system are particularly suited to be carried out by a computer software program, such program containing modules corresponding to one or more of the individual steps or acts described and/or envisioned by the present system. Such program and elements thereof may of course be embodied in a computer-readable medium, such as an integrated chip, a peripheral device or memory, and/or other one or more memories coupled to the one or more processors.

One or more of the memories may be any recordable medium (e.g., RAM, ROM, removable memory, CD-ROM, hard drives, DVD, floppy disks or memory cards) or may be a transmission medium (e.g., a network comprising fiber-optics, the world-wide web, cables, a wireless channel using time-division multiple access, code-division multiple access, other radio-frequency and/or wireless communication channel). Any medium known or developed that may store and/or transmit information suitable for use with a computer system, processor, etc., may be used as one or more of the memories.

These memories may configure the processor to render the GUIs and implement the methods, operational acts, and functions disclosed herein. The memories may be distributed or local and the processor, where additional processors may be provided, may also be distributed or may be singular. For example, the GUI may be embedded in a web-based application that is wholely or partially provided by a remote processor. The memories may be implemented as electrical, magnetic or optical memory, or any combination of these or other types of storage devices. Moreover, the term “memory” should be construed broadly enough to encompass any information able to be read from or written to an address in the addressable space accessible by a processor. With this definition, information on a network is still within the memory, for instance, because the processor may retrieve the information from the network for operation in accordance with the present system.

The one or more processors may be capable of providing control signals and/or performing operations in response to input signals from a user input device and executing instructions stored in the one or more memories. One or more of the processors may be an application-specific and/or general-use integrated circuit(s). Further, the processors may be a dedicated processor for performing in accordance with the present system and/or may be a general-purpose processors wherein only one of many functions operates for performing in accordance with the present system. The one or more processors may operate utilizing a program portion, multiple program segments, and/or may be a hardware device utilizing a dedicated or multi-purpose integrated circuit. Further, in a distributed system, portions of an operation may be performed on one device with data generated therefrom being transferred to one or more further devices.

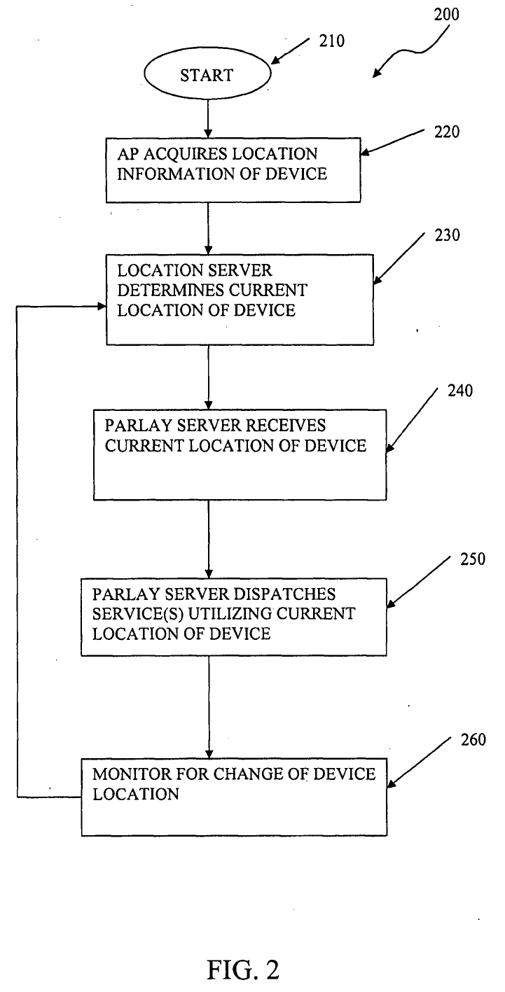

Further operation of the present system will be illustrated with reference to FIG. 2 which shows a process flow diagram 200 in accordance with an embodiment of the present system. During act 210, the process may begin when the device 120 enters an area within WiFi network 110 or a service area of the cellular AP 130. Further, the process may begin when the device 120 switches between the cellular AP 130 and AP 112. During act 220, the AP determines location information about the device 120. For example, in one embodiment in accordance with the present system, the device 120 may be operating (e.g., communicating) on the WiFi network 110 and the AP 112 may include a positioning module for determining a position of the device 120. In this embodiment, the positioning module may determine a relative location of the device 120 from the AP 112, such as within an X-Y coordinate space. In one embodiment, the X-Y coordinate space may be determined utilizing triangulation techniques which may be converted to a longitude and latitude location by the positioning module (AP 112) or the X-Y coordinate space information may be transferred to the location mapping engine 144, which together with the location information related to the AP 112 from the location database 170, may convert the X-Y coordinate space into a longitude and latitude location (or an address location) during act 230.

In one embodiment; to or more APs 112 may provide device location information for determining an X-Y coordinate of the device 120. In the same or a further embodiment, the APs 112 may provide X-Y-Z coordinate information that may be converted to longitude, latitude and altitude information of the device 120. In this way, for example, the device 120 location information may be converted to an address and floor location, such as 110 Tenth Avenue, 4th floor, Bronx, N.Y. This type of information may be particularly useful for services wherein the altitude information is particularly relevant, such as an E911 service. In another service, a request may be made to identify a nearest printer, phone, and/or other resource wherein the altitude information may be utilized to filter resources that are located physically closer to the device 120, but may be located on a different floor than the device 120. In this embodiment, either of the location server 140 and/or the APs 112 (e.g., location mapping engine 144 and/or location correlation engine 142) may determine the altitude information of the device 120. In a further embodiment, one or more APs 112 may determine and/or provide the device 120 location (e.g., coordinate information) together with the cellular AP 130. For example, in one embodiment, the device 120 may be in operable communication with both of the one or more APs 112 and the cellular AP 130. The device 120 location from the one or more APs 112 and the cellular AP 130 may include X-Y coordinate information alone, or together with Z (altitude) coordinate information.

During act 240, the parlay server 150 receives the device location information and in accordance with tools provided within Parlay, may dispatch a service during act 250. Thereafter, the system 100 may monitor for a change in device location during act 260 to determine a new device location (e.g., acts 230 and so on).

The present system/device/method provides numerous benefits of prior systems. For example, through use of the present system/device/method in accordance with an embodiment, an integrated cellular and WiFi service may be deployed using simplified tools, such as Parlay tools, without hindering a service provider with requiring an intimate understanding of an underlying infrastructure.

Of course, it is to be appreciated that any one of the above embodiments or processes may be combined with one or more other embodiments and/or processes or be separated and/or performed amongst separate devices or device portions in accordance with the present system.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. An Application Programming Interface (API) stored on a processor readable memory medium, the API comprising:
a portion arranged to receive device position information from an Access Point (AP);
a portion arranged to receive a service request for the device from a cellular based service system; and
a portion arranged to provide information to the device responsive to the service request and the device position information.

2. The API of claim 1, comprising a location server arranged to evaluate the device position information and translate the device position information to appropriate position information based on the service request.

3. The API of claim 1, wherein the cellular based service system is a Parlay server.

4. The API of claim 1, wherein the portion arranged to receive device position information is arranged to receive updated device position information and to update the information to the device responsive to the updated device position information.

5. The API of claim 4, wherein the API is arranged to evaluate a difference between the updated device position information and the device position information and is arranged to provide the information to the device responsive to the difference.

6. The API of claim 5, wherein the difference is evaluated to determine a rate of travel of the device to determine if the device is traveling at a vehicular rate of travel and to provide the information to the device including an area around the device based on if the device is traveling at a vehicular rate of travel.

7. The API of claim 1, wherein the API includes a portion arranged to evaluate the device position information utilizing a location database and a location rules manager.

8. The API of claim 1, wherein the portion arranged to receive the device position information is arranged to determine if the device switches to a cellular Access Point (AP) and if so, is arranged to receive further device position information from the cellular AP and is arranged to provide updated information to the device responsive to the service request and the updated device position information.

9. The API of claim 1, wherein the device position information includes coordinate position information.

10. The API of claim 9, wherein the coordinate position information includes a coordinate related to an altitude of the device.

11. The API of claim 1, wherein the position information includes a position related to an altitude of the device.

12. The API of claim 11, wherein the portion arranged to receive the device position information is arranged to evaluate the altitude of the device and to convert the altitude to a floor location of the device, wherein the portion arranged to provide information to the device is responsive to the altitude of the device.

13. A method of providing a unified system for interaction with cellular and internet protocol devices, the method comprising acts of:
receiving device position information from an Access Point (AP);
receiving a service request for the device from a cellular based service system; and
providing information to the device responsive to the service request and the device position information.

14. The method of claim 13, comprising acts of:
evaluating the device position information; and
translating the device position information to suitable position information based on the service request.

15. The method of claim 13, wherein the act of receiving device position information comprises acts of:
receiving updated device position information; and
updating the information to the device responsive to the updated device position information.

16. The method of claim 15, comprising acts of:
evaluating a difference between the updated device position information and the device position information; and
providing the information to the device responsive to the difference.

17. The method of claim 16., wherein the act of evaluating the difference comprises acts of:
evaluating the difference to determine a rate of travel of the device to determine if the device is traveling at a vehicular rate of travel; and
providing the information to the device including an area around the device based on if the device is traveling at a vehicular rate of travel.

18. The method of claim 13, wherein the act of evaluating the device position information utilizes a location database and a location rules manager.

19. The method of claim 13, comprising an act of determining if the device switches to a cellular Access Point (AP) and if so, the method comprises acts of:
receiving further device position information from the cellular AP; and
providing updated information to the device responsive to the service request and the updated device position information.

20. The method of claim 13, wherein the device position information includes coordinate position information.

21. The method of claim 20, wherein the coordinate position information includes a coordinate related to an altitude of the device.

22. The method of claim 13, wherein the position information includes a position related to an altitude of the device.

23. The method of claim 22, the method comprising acts of:
evaluating the altitude of the device;
converting the altitude to a floor location of the device; and
providing the information to the device responsive to the altitude of the device.
